(19) United States
(12) Patent Application Publication
(10) Pub. No.: US 2015/0074451 A1
(43) Pub. Date: Mar. 12, 2015

(54) MEMORY SYSTEM

(71) Applicant: Kabushiki Kaisha Toshiba, Minato-ku (JP)

(72) Inventors: Norikazu YOSHIDA, Kawasaki-shi (JP); Akihiro Sakata, Yokohama-shi (JP)

(73) Assignee: Kabushiki Kaisha Toshiba, Minato-ku (JP)

(21) Appl. No.: 14/197,396

(22) Filed: Mar. 5, 2014

Related U.S. Application Data
(60) Provisional application No. 61/876,275, filed on Sep. 11, 2013.

(51) Int. Cl. G06F 11/20; G06F 11/10

(52) U.S. Cl. CPC G06F 11/2058; G06F 11/108
USPC 714/6.23

(57) ABSTRACT

According to one embodiment, there is provided a memory system including a first storage medium group, a second storage medium group, and a controller. The controller is configured to multiply write the same data to the first storage medium group and the second storage medium group. And the controller is configured to transmit data read out from a storage medium group selected from the first storage medium group and the second storage medium group to a host according to a progress status of a readout process for the first storage medium group and the second storage medium group when receiving a readout command of stored data in the first storage medium group and the second storage medium group from the host.

### CROSS-REFERENCE TO RELATED APPLICATIONS

This application is based upon and claims the benefit of priority from Provisional Application No. 61/876,275, filed on Sep. 11, 2013; the entire contents of which are incorporated herein by reference.

### FIELD

Embodiments described herein relate generally to a memory system.

### BACKGROUND

Miniaturization and higher integration are advancing in semiconductor processes of recent years, and a threshold value of a memory cell has a tendency to easily change by the influence of proximity cells, the influence of electronic traps, and the like from a usage environment such as temperature and aging in a storage medium such as a NAND flash memory. In addition, since the threshold value itself is sometimes handled in multi-level form in the storage medium such as the NAND flash memory, and the like, the data stored in the storage medium tends to easily change. A configuration for protecting the data is necessary to handle such storage medium.

### BRIEF DESCRIPTION OF THE DRAWINGS

FIG. 1 is a view illustrating a configuration of a memory system according to a first embodiment;

FIG. 2 is a flowchart illustrating an operation of the memory system according to the first embodiment;

FIG. 3 is a view illustrating the operation of the memory system according to the first embodiment;

FIG. 4 is a view illustrating the operation of the memory system according to the first embodiment;

FIG. 5 is a flowchart illustrating an operation of a memory system according to a second embodiment;

FIG. 6 is a view illustrating the operation of the memory system according to the second embodiment;

FIG. 7 is a view illustrating the operation of the memory system according to the second embodiment;

FIG. 8 is a view illustrating the operation of the memory system according to the second embodiment;

FIG. 9 is a flowchart illustrating an operation of a memory system according to a third embodiment;

FIG. 10 is a view illustrating the operation of the memory system according to the third embodiment;

FIG. 11 is a view illustrating the operation of the memory system according to the third embodiment;

FIG. 12 is a view illustrating the operation of the memory system according to the third embodiment;

FIG. 13 is a view illustrating the operation of the memory system according to the third embodiment;

FIG. 14 is a flowchart illustrating an operation of a memory system according to a fourth embodiment; and

FIG. 15 is a view illustrating the operation of the memory system according to the fourth embodiment.

### DETAILED DESCRIPTION

In general, according to one embodiment, there is provided a memory system including a first storage medium group, a second storage medium group, and a controller. The controller is configured to multiply write the same data to the first storage medium group and the second storage medium group. And the controller is configured to transmit data read out from a storage medium group selected from the first storage medium group and the second storage medium group to a host according to a progress status of a readout process for the first storage medium group and the second storage medium group when receiving a readout command of stored data in the first storage medium group and the second storage medium group from the host.

Exemplary embodiments of a memory system will be explained below in detail with reference to the accompanying drawings. The present invention is not limited to the following embodiments.

### First Embodiment

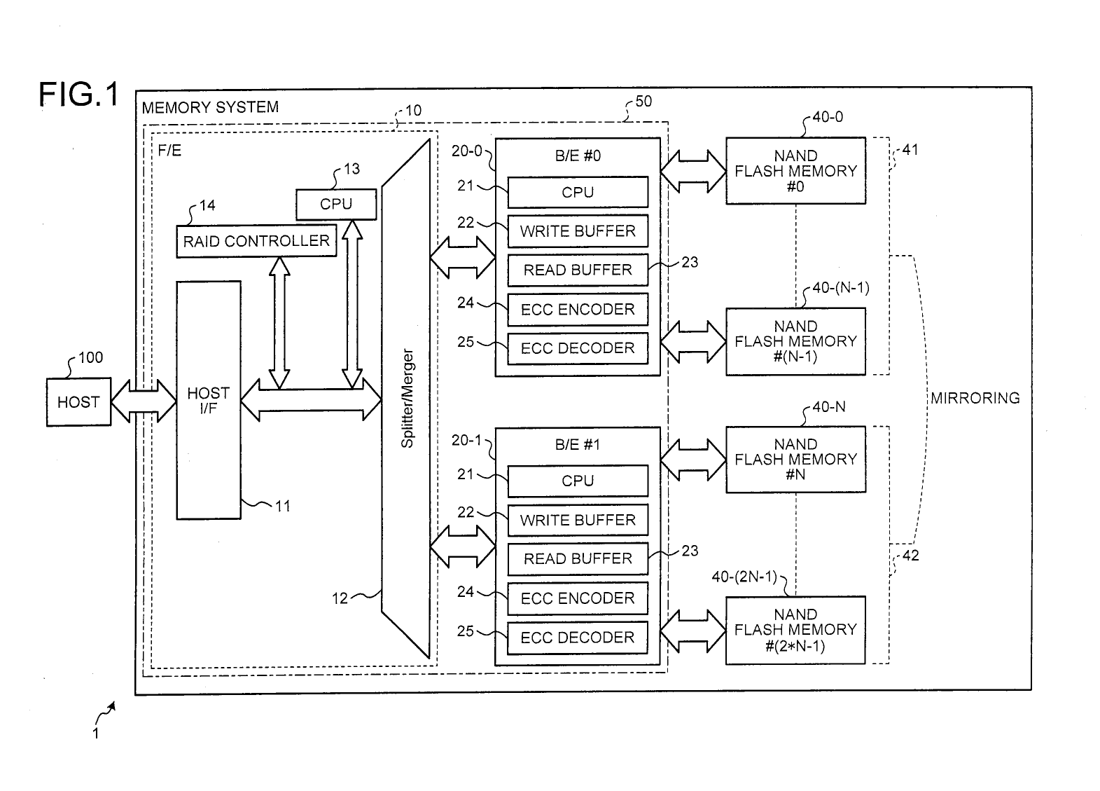

A memory system 1 according to a first embodiment will be described using FIG. 1. FIG. 1 is a view illustrating a configuration of the memory system 1.

The memory system 1 is connected to an exterior of a host 100 through a communication medium, and functions as an external storage medium with respect to the host 100. The host 100 includes, for example, a personal computer or a CPU core. The memory system 1 includes, for example, an SSD (Solid State Drive).

In the memory system 1, data is stored using a plurality of NAND flash memories 40-0 to 40-(2N−1).

Each NAND flash memory 40 has a memory cell array in which a plurality of memory cells are arrayed in a matrix form, where the individual memory cell can multiply store using a higher-level page and a lower-level page. In each NAND flash memory 40, the erasure of the data is carried out in units of blocks, whereas the write and readout of data are carried out in units of pages. The block is a unit in which a plurality of pages are gathered together. Furthermore, in each NAND flash memory 40, the interior data management by the CPU 13 is carried out in units of clusters, and the update of the data is carried out in units of sectors. In the present embodiment, the page is a unit in which a plurality of clusters are gathered together, and the cluster is a unit in which a plurality of sectors are gathered together. The sector is a minimum access unit of data from the host 100, and has, for example, a size of 512B. The host 100 specifies the data to access with an LBA (Logical Block Addressing) in units of sectors.

In each NAND flash memory 40, a threshold value of a memory cell (transistor) has a tendency to easily change by the influence of proximity cells, the influence of electronic traps, and the like from a usage environment such as temperature and aging. Furthermore, since the threshold value itself is sometimes handled in multi-level form in each NAND flash memory 40, the data stored in the NAND flash memory 40 tends to easily change. Therefore, a configuration for protecting the data is necessary in the memory system 1.

The configuration for protecting the data may be, in addition to the configuration for realizing the error detection/correction process by various types of ECC (Error Checking and Correction) and the error detection function such as parity, CRC (Cyclic Redundancy Check), and the like, a configuration for multiple data protection such as a so-called RAID (Redundant Arrays of Inexpensive Disks) 1 system. In the RAID 1 system, mirroring in which the same data is multiply written to at least two or more storage devices is carried out. According to such mirroring, when damage of data occurs in one of the two storage devices, for example, the same data can be read out from the other storage device, thus ensuring fault tolerance and redundancy.

The memory system 1 includes a first storage medium group 41, a second storage medium group 42, and a controller 50. The first storage medium group 41 includes a plurality of NAND flash memories (plurality of storage media) 40-0 to 40-(N−1). The NAND flash memories 40-0 to 40-(N−1) may be different chips from each other, for example. The second storage medium group 42 includes a plurality of NAND flash memories (plurality of storage media) 40-N to 40-(2N−1). The NAND flash memories 40-N to 40-(2N−1) may be different chips from each other, for example.

The controller 50 controls the first storage medium group 41 and the second storage medium group 42 as the RAID 1 system. For example, the controller 50 carries out mirroring of multiply writing the same data to the first storage medium group 41 and the second storage medium group 42, and multiplexing the write data between the first storage medium group 41 and the second storage medium group 42. The controller 50 may carry out the write of data to the first storage medium group 41 and the second storage medium group 42 in parallel or in series.

When carrying out the mirroring of data in the RAID 1 system, round-robbin method, geometric method, fixation method, and the like can be considered for the readout algorithm.

In the round-robbin method, a plurality of sub-mirrors, that is, a plurality of storage medium groups to mirror is sequentially selected, and the data is read out from the selected storage medium group. This method is based on the idea that the processing load on the storage medium groups can be uniformed by sequentially selecting the storage medium group and reading out the data therefrom.

In the geometric method, the reading process is dispersed to a plurality of sub-mirrors, that is, a plurality of storage medium groups based on a logical disc block addressing (LBA). For example, in the case of a two-face sub-mirror, a disc region of a plurality of mirrored storage medium groups is divided into the two logical address regions based on the logical address (LBA), where the reading to one sub-mirror is limited to one logical address and the reading to the other sub-mirror is limited to the other logical address region. This method is based on the idea that the processing load on the storage medium groups can be uniformed by changing the storage medium group to be read geometrically (geometric arrangement order) in the disc region.

In the fixation method, all reading processes are limited to a certain sub-mirror, that is, a certain storage medium group. This is based on the idea that if the processing speed of a certain storage medium group is higher than the other storage medium groups, the performance of the readout process of the storage medium group can be enhanced.

Such readout algorithms are all based on the assumption that the processing load of a plurality of storage medium groups that are mirrored is substantially constant temporally. Thus, for example, only one storage medium group of the plurality of storage medium groups that are mirrored is selected and driven. However, if the processing loads of the plurality of storage medium groups are temporally fluctuated, for example, if the storage medium group being driven is busy for some reason, the readout process tends to become long and the performance of the memory system 1 may lower.

It should be noted that a state in which the storage medium is busy is, for example, defined as a state in which a ready/busy signal (Ry/By) of a ready busy signal line (R/B) connected to the storage medium and indicating whether or not the storage medium is operable is falling to busy. A state in which the storage medium is not busy is, for example, defined as a state in which the ready/busy signal (Ry/By) of the ready busy signal line (R/B) connected to the storage medium and indicating whether or not the storage medium is operable is rising to ready. Furthermore, for example, whether ready or busy can be inquired with respect to the storage medium and determination can be made according to the response result without using the ready busy signal line (R/B).

For example, if the processing time by the ECC correction is generated, or the process such as compaction, wear leveling, and the like executed as the background process is executed for the selected storage medium group, the readout process of the memory system 1 tends to have a heavy load and the performance of the memory system 1 may lower.

In other words, in the readout algorithms described above, it is not assumed that only the response from one side of a pair of mirrors may become very slow when performing mirroring between the first storage medium group 41 and the second storage medium group 42. In the memory system 1, at the time of execution of a large-scale correction process or when delay by the process such as compaction, wear leveling, and the like interiorly carried out as the background process occurs, there is a need to take into consideration the measures therefor.

In the present embodiment, therefore, a novel readout algorithm is adopted in the memory system 1. In other words, the present embodiment aims to increase the speed of the readout process in the memory system 1 by carrying out control of adopting the readout data from the storage medium selected according to the progress status of the readout process from the first storage medium group 41 and the second storage medium group 42, which are mirrored with respect to each other in the memory system 1. The novel readout algorithm in the present embodiment will be hereinafter referred to as a high-speed readout algorithm.

Specifically, the controller 50 of the memory system 1 includes a front end (F/E) 10, a first back end (B/E #0) 20-0, and a second back end (B/E #1) 20-1.

The front end 10 is connected to the host 100. The front end 10 is connected between the host 100 and the first back end 20-0, and is connected between the host 100 and the second back end 20-1.

For example, when receiving a write command and data from the host 100, the front end 10 issues a write request according to the write command. In this case, the front end 10 issues the write request for the first storage medium group 41 and for the second storage medium group 42. The front end 10 provides the write request for the first storage medium group 41 to the back end 20-0, and provides the write request for the second storage medium group 42 to the second back end 20-1. The front end 10 thus can perform control to multiplex and write the same data to be written for the first storage medium group 41 and for the second storage medium group 42.

Furthermore, for example, when receiving a readout command from the host 100, the front end 10 issues a readout request according to the readout command. In this case, the front end 10 issues the readout request for the first storage medium group 41 and for the second storage medium group 42 according to the high-speed readout algorithm. The front end 10 provides the readout request for the first storage medium group 41 to the first back end 20-0, and provides the readout request for the second storage medium group 42 to the second back end 20-1.

The front end 10 selects the storage medium group, which has returned the response first, among the first storage medium group 41 and the second storage medium group 42, adopts the data read out from the selected storage medium group, and transmits the data to the host 100 according to the high-speed readout algorithm. For example, when receiving the data first from the first back end 20-0 among the first back end 20-0 and the second back end 20-1, the front end 10 selects the first storage medium group 41 and transmits the data (data from the first storage medium group 41) received from the first back end 20-0 to the host 100. Thus, the data of the storage medium group, in which the advancement of the readout process is faster, of the first storage medium group 41 and the second storage medium group 42 can be adopted and transmitted to the host 100, whereby the memory system 1 can shorten the time for the readout process even when the response of one of the first back end 20-0 and the second back end 20-1 is very slow.

The front end 10 drops the readout request for the non-selected storage medium group. For example, when receiving the data first from the first back end 20-0 among the first back end 20-0 and the second back end 20-1, the front end 10 notifies the second back end 20-1 that the readout request will be dropped. Alternatively, the front end 10 discards the data read out from the non-selected storage medium group. For example, when receiving the data first from the first back end 20-0 among the first back end 20-0 and the second back end 20-1, the front end 10 discards the data subsequently received from the second back end 20-1.

The front end 10 includes a host interface 11, a splitter/merger 12, a CPU 13, and a RAID controller 14.

The host interface 11 interfaces with the splitter/merger 12, the CPU 13, as well as the RAID controller 14, and the host 100. The host interface 11 receives signals (e.g., command, data) from the host 100, and transmits signals to the host 100. The CPU 13 performs various types of control operations such as comprehensively controlling each configuring element of the memory system 1, and the like according to the command from the host 100. The RAID controller 14 performs the control so that the first storage medium group 41 and the second storage medium group 42 operate as the RAID 1 system. The splitter/merger 12 interfaces with the host interface 11, and the first back end 20-0 as well as the second back end 20-1.

For example, when receiving the write command and the data from the host 100, the host interface 11 provides the write command to the CPU 13. The CPU 13 issues the write request according to the write command. In this case, the CPU 13 issues the write request for the first storage medium group 41 and for the second storage medium group 42, respectively, and provides the same to the splitter/merger 12 according to the request from the RAID controller 14. The CPU 13 provides the data to be written to the splitter/merger 12. The splitter/merger 12 duplicates (copies) the same data to be written for the first storage medium group 41 and for the second storage medium group 42. The splitter/merger 12 provides the write request and the data to be written of the first storage medium group 41 to the first back end 20-0, and provides the write request and the data to be written of the second storage medium group 42 to the second back end 20-1.

For example, when receiving the readout command from the host 100, the host interface 11 provides the readout command to the CPU 13. The CPU 13 issues the readout request according to the readout command. In this case, the CPU 13 issues the readout request for the first storage medium group 41 and for the second storage medium group 42, and provides the same to the splitter/merger 12 according to the high-speed readout algorithm. The splitter/merger 12 provides the readout request for the first storage medium group 41 to the first back end 20-0, and provides the readout request for the second storage medium group 42 to the second back end 20-1.

When receiving a response first from one back end among the first back end 20-0 and the second back end 20-1 through the splitter/merger 12, the CPU 13 selects the storage medium group, which has returned the response first, among the first storage medium group 41 and the second storage medium group 42, adopts the data read out from the selected storage medium group, and provides the data to the host interface 11 according to the high-speed readout algorithm. The host interface 11 transmits the provided data to the host 100.

For example, when receiving the data first from the first back end 20-0 among the first back end 20-0 and the second back end 20-1, the CPU 13 selects the first storage medium group 41, adopts the data (data from the first storage medium group 41) received from the first back end 20-0, and provides the data to the host interface 11. The host interface 11 transmits the data from the first storage medium group 41 to the host 100.

The CPU 13 drops the readout request for the non-selected storage medium group according to the high-speed readout algorithm. For example, when receiving the data first from the first back end 20-0 among the first back end 20-0 and the second back end 20-1, the CPU 13 notifies the second back end 20-1 that the readout request will be dropped through the splitter/merger 12. Alternatively, the CPU 13 controls the splitter/merger 12 and discards the data read out from the non-selected storage medium group. For example, when receiving the data first from the first back end 20-0 among the first back end 20-0 and the second back end 20-1, the CPU 13 controls the splitter/merger 12 to discard the data the splitter/merger 12 subsequently receives from the second back end 20-1.

In the description made above, a case in which the high-speed readout algorithm is implemented in a form of a circuit in the CPU 13 has been illustratively described, but the high-speed readout algorithm may be implemented in a form of a circuit in the splitter/merger 12, may be implemented in a form of a circuit in the RAID controller 14, may be implemented in a form of a circuit in the host interface 11, or may be implemented in a form of software in a firmware executed by the CPU 13.

The first back end 20-0 is connected between the front end 10 and the first storage medium group 41. The first back end 20-0 interfaces with the front end 10 and the first storage medium group 41. The second back end 20-1 is connected between the front end 10 and the second storage medium group 42. The second back end 20-1 interfaces with the front end 10 and the second storage medium group 42. In other words, in the controller 50, the portion that controls the storage medium group is multiplexed to the first back end 20-0 and the second back end 20-1 in correspondence with the multiplexing of the storage medium group to the first storage medium group 41 and the second storage medium group 42. In other words, the first back end 20-0 and the second back end 20-1 configure a sub-mirror for mirroring in the RAID 1 system.

The first back end 20-0 includes a CPU 21, a write buffer 22, a read buffer 23, an ECC encoder 24, and an ECC decoder 25. The CPU 21 performs the control operation for the first storage medium group 41 according to the request received from the front end 10. For example, the CPU 21 writes data to the first storage medium group 41 according to the write request received from the front end 10. In this case, the write buffer 22 functions as a buffer region of the data to be written to the first storage medium group 41. Alternatively, for example, the CPU 21 reads out the data from the first storage medium group 41 according to the readout request received from the front end 10. The read buffer 23 functions as a buffer region of the data read out from the first storage medium group 41.

The ECC encoder 24 performs encoder process in the ECC process (error correction process), adds the encode result (ECC code) to the data, and outputs the same to the write buffer 22 when writing the data to the first storage medium group 41. The CPU 21 thus writes the information in which the ECC code is added to the data to be written to the first storage medium group 41. The ECC encoder 24, for example, performs the encode process of four stages, a first ECC code (L1), a second ECC code (L2), a third ECC code (L3), and a fourth ECC code (L4). The dispersion extent of the encoding process becomes higher and the amount of data and number of pages of the encoding target become larger, and thus the processing load becomes heavier in the order of the first ECC code (L1), the second ECC code (L2), the third ECC code (L3), and the fourth ECC code (L4).

The ECC decoder 25 can perform the decode process (error correction process using the error correcting code) in the ECC process (error correction process) in a step-wise manner when reading out the data from the first storage medium group 41. For example, the ECC decoder 25 extracts the ECC code from the information read out from the first storage medium group 41, and performs the error correction process using the extracted ECC code. In other words, the ECC decoder 25 first extracts the first ECC code (L1) and performs the error correction process using the first ECC code (L1), and when an ECC error occurs and the error correction process fails, extracts the second ECC code (L2) and performs the error correction process using the second ECC code (L2). Thus, the error correction process can be carried out while enlarging the scale in a step-wise manner in the order of the first ECC code (L1), the second ECC code (L2), the third ECC code (L3), and the fourth ECC code (L4) until the error correction process is successful.

Similarly, the second back end 20-1 includes the CPU 21, the write buffer 22, the read buffer 23, the ECC encoder 24, and the ECC decoder 25. The function of each unit in the second back end 20-1 is similar to the above.

It should be noted that the write buffer 22 and the read buffer 23 may be arranged in the splitter/merger 12 of the front end 10, for example, instead of being arranged in the first back end 20-0 and the second back end 20-1, respectively. In other words, the write buffer 22 and the read buffer 23 may be arranged as a buffer common to the first back end 20-0 and the second back end 20-1 in the splitter/merger 12 of the front end 10.

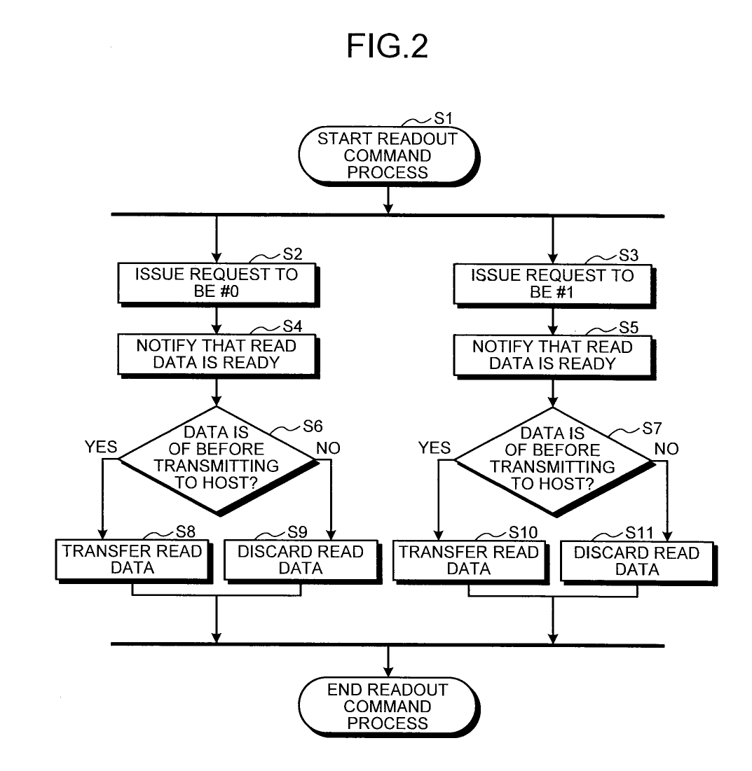

The operation of the memory system 1 will now be described using FIG. 2. FIG. 2 is a flowchart illustrating the operation of the memory system 1.

When receiving the readout command from the host 100, the front end 10 issues the readout request to both back ends 20-0, 20-1 performing the mirroring.

Specifically, in step S1, the front end 10 receives the readout command from the host 100, and starts the process of the readout command.

In step S2, the front end 10 issues the readout request for the first storage medium group 41, and provides the same to the first back end 20-0.

In step S3, the front end 10 issues the readout request for the second storage medium group 42, and provides the same to the second back end 20-1.

The front end 10 performs the control such that the process of step S2 and the process of step S3 are carried out in parallel.

The front end 10 adopts the data transfer from the back end in which the read data became ready first of the mirrored back ends 20-0, 20-1, and drops the readout request to the other back end, or discards the response data.

Specifically, in step S4, the first back end 20-0 reads out the data from the first storage medium group 41, and after the data read out (read data) is ready, notifies the front end 10 that the data is ready according to the readout request from the first storage medium group 41. In other words, the first back end 20-0 notifies the front end 10 that the data is ready after the readout process is completed. The first back end 20-0 may provide the data itself that is read out to the front end 10 instead of notifying the front end 10 that the data is ready as a response to the front end 10.

In step S5, the second back end 20-1 reads out the data from the second storage medium group 42 according to the readout request from the second storage medium group 42, and after the data read out (read data) is ready, notifies the front end 10 that the data is ready. In other words, the second back end 20-1 notifies the front end 10 that the data is ready after the readout process is completed. The second back end 20-1 may provide the data itself that is read out to the front end 10 instead of notifying the front end 10 that the data is ready as a response to the front end 10.

In step S6, the front end 10 determines whether or not the data (read data) read out from the first storage medium group 41 is the data of before transmitting to the host 100. The front end 10 proceeds the process to step S8 if the read data is the data of before transmitting to the host 100 (Yes in step S6), and proceeds the process to step S9 if the read data is the data already transmitted to the host 100 (No in step S6).

In step S8, the front end 10 acquires the data read out from the first storage medium group 41 from the first back end 20-0, and transmits the data to the host 100 according to the notification that the data is ready. Alternatively, the front end 10 transmits the data received from the first back end 20-0 in step S4 to the host 100.

In step S9, the front end 10 drops the readout request for the second storage medium group 42. For example, the front end 10 notifies the second back end 20-1 that the readout request will be dropped. Alternatively, the front end 10 discards the data read out from the second storage medium group 42. For example, when receiving the data from the second back end 20-1, the front end 10 discards such data.

In step S7, the front end 10 determines whether or not the data (read data) read out from the second storage medium group 42 is the data of before transmitting to the host 100. The front end 10 proceeds the process to step S10 if the read data is the data of before transmitting to the host 100 (Yes in step S7), and proceeds the process to step S11 if the read data is the data already transmitted to the host 100 (No in step S7).

In step S10, the front end 10 acquires the data read out from the second storage medium group 42 from the second back end 20-1, and transmits the data to the host 100 according to the notification that the data is ready. Alternatively, the front end 10 transmits the data received from the second back end 20-1 in step S5 to the host 100.

In step S11, the front end 10 drops the readout request for the first storage medium group 41. For example, the front end 10 notifies the first back end 20-0 that the readout request will be dropped. Alternatively, the front end 10 discards the data read out from the first storage medium group 41. For example, when receiving the data from the first back end 20-0, the front end 10 discards such data.

According to such processes, even if a certain back end storage region is busy, the data from another region that is not busy can be used to return the response to the host 100, so that stable performance can be derived for the readout process in the memory system 1. For example, it is particularly effective when a delay factor of the back ends 20-0, 20-1 that cannot be predicted on the front end 10 side such as the time of ECC error occurrence, and the like occurs.

For example, each NAND flash memory 40-1 to 40-(N−1) in the first storage medium group 41 individually outputs the ready/busy signal (Ry/By) to the first back end 20-0 periodically or in response to the inquiry from the first back end 20-0. When receiving the ready/busy signal (Ry/By) from the NAND flash memory 40-1 to 40-(N−1), the first back end 20-0 checks if each NAND flash memory 40-1 to 40-(N−1) is in the ready state or the busy state. The first back end 20-0 thus can directly grasp whether or not the first storage medium group 41 is busy.

Similarly, each NAND flash memory 40-N to 40-(2N−1) in the second storage medium group 42 individually outputs the ready/busy signal (Ry/By) to the second back end 20-1 periodically or in response to the inquiry from the second back end 20-1. When receiving the ready/busy signal (Ry/By) from the NAND flash memory 40-N to 40-(2N−1), the second back end 20-1 checks if each NAND flash memory 40-N to 40-(2N−1) is in the ready state or the busy state. The second back end 20-1 thus can directly grasp whether or not the second storage medium group 42 is busy.

On the other hand, the front end 10 cannot directly grasp whether or not in the busy state for both the first storage medium group 41 and the second storage medium group 42, but can indirectly grasp whether or not in the busy state for the first storage medium group 41 and the second storage medium group 42 by performing the processes described above, and hence stable performance can be derived for the readout process in the memory system 1.

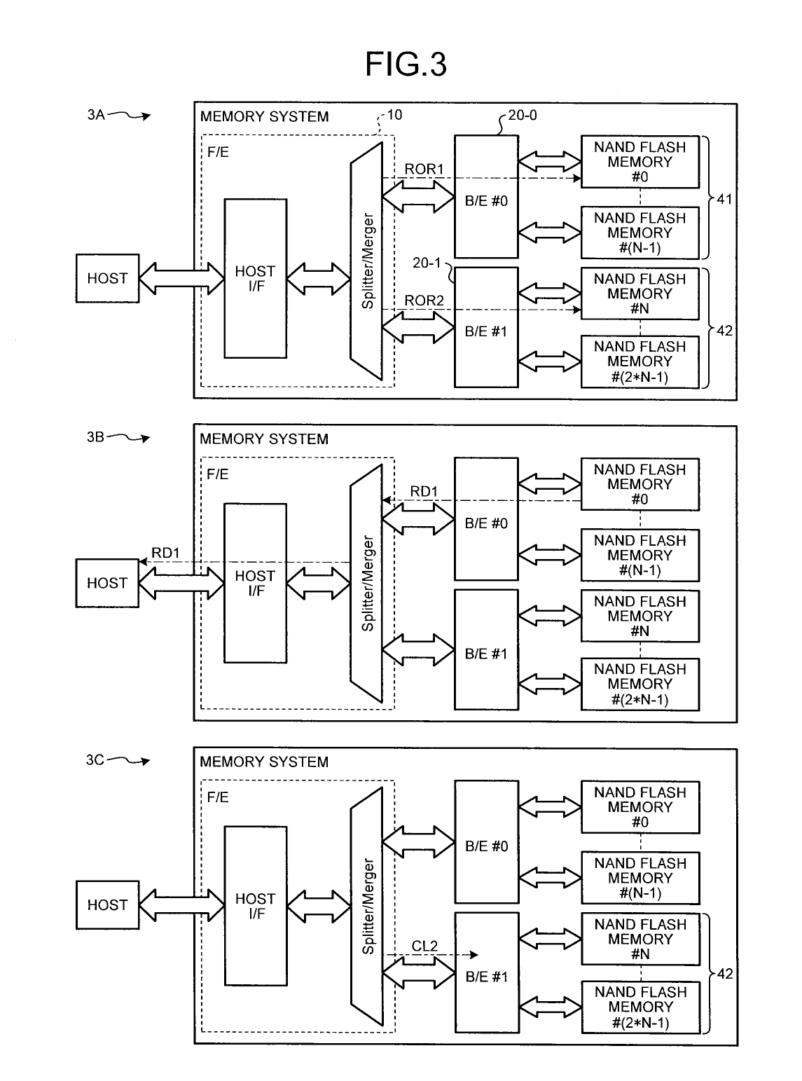

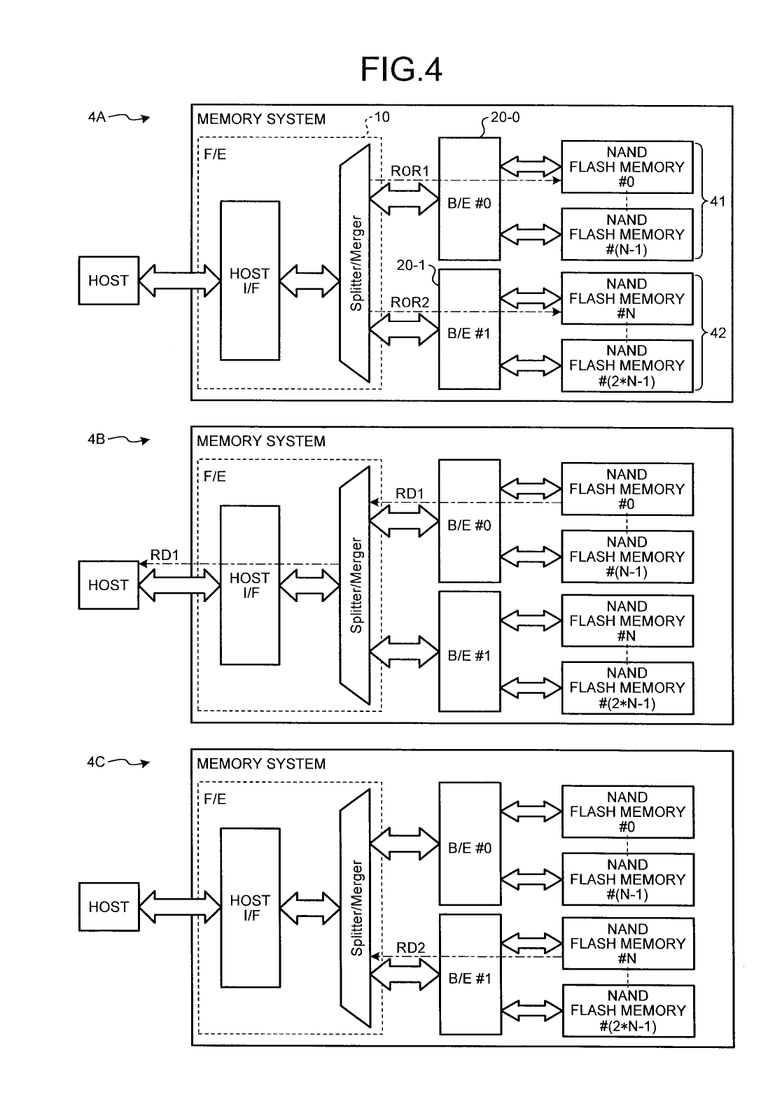

A specific operation example of the memory system 1 will now be described using FIGS. 3 and 4. FIGS. 3 and 4 are views illustrating the operation of the memory system 1.

For example, in 3A of FIG. 3, the front end 10 receives a readout command from the host 100, and issues a readout request according to the readout command. In this case, the front end 10 issues the readout requests ROR1, ROR2 for the first storage medium group 41 and for the second storage medium group 42 according to the high-speed readout algorithm. The front end 10 provides the readout request ROR1 of the first storage medium group 41 to the back end 20-0, and provides the readout request ROR2 of the second storage medium group 42 to the second back end 20-1.

In 3B of FIG. 3, the front end 10 selects the storage medium group, which has returned the response first, among the first storage medium group 41 and the second storage medium group 42, adopts the data read out from the selected storage medium group, and transmits the same to the host 100 according to the high-speed readout algorithm. For example, when receiving the data RD1 first from the first back end 20-0 among the first back end 20-0 and the second back end 20-1, the front end 10 selects the first storage medium group 41 and transmits the data RD1 received from the first back end 20-0 to the host 100.

In 3C of FIG. 3, the front end 10 drops the readout request for the second storage medium group 42 that is not selected. For example, the front end 10 supplies a notification CL2 that the readout request will be dropped to the second back end 20-1. In accordance therewith, the second back end 20-1 stops the readout process of the data from the second storage medium group 42.

Alternatively, for example, the operations similar to 3A, 3B of FIG. 3 are carried out in 4A, 4B of FIG. 4. In 4C of FIG. 4, the front end 10 discards the data RD2 read out from the second storage medium group 42 that is not selected. For example, the front end 10 discards the data RD2 received from the second back end 20-1.

It should be noted that, theoretically, the preparation of the read data may be simultaneously completed. In this case, since the readout process inside the NAND flash memory is already in the completed state, the data of either sub-mirror that is ready may be adopted without a problem, taking into consideration only the worn degree of the NAND flash memory. Thus, if the read buffer is shared between the two back ends, a difference rarely arises even if the data is selected with a fixed priority. If the read buffer is independently arranged for each back end, equalization is preferably carried out in view of the usage efficiency. The process of efficiently selecting in the selection of the storage medium group by the round-robbin, determination based on the usage amount of the read buffer, and the like may be added.

As describe above, in the first embodiment, when the controller 50 receives the readout command from the host 100 in the memory system 1, the data read out from the storage medium group selected from the first storage medium group 41 and the second storage medium group 42 is transmitted to the host 100 according to the progress status of the readout process for the first storage medium group 41 and the second storage medium group 42 mirrored with respect to each other. For example, when receiving the readout command from the host 100, the controller 50 issues the readout requests ROR1, ROR2 for the first storage medium group 41 and the second storage medium group 42, adopts the data read out from the storage medium group, which has returned the response first, among the first storage medium group 41 and the second storage medium group 42 and transmits the same to the host 100. Thus, the data of the storage medium group, in which the advancement of the readout process is faster, among the first storage medium group 41 and the second storage medium group 42 can be adopted and transmitted to the host 100, whereby the time of the readout process can be easily shortened even when the response of one of the first back end 20-0 and the second back end 20-1 is very slow. Therefore, the stable performance can be derived even when the response from one storage medium group is slow, and the speed of the readout process can be increased for the first storage medium group 41 and the second storage medium group 42 mirrored with respect to each other in the memory system 1.

Furthermore, in the first embodiment, when receiving the readout command from the host 100, the front end 10 provides the readout request ROR1 of the first storage medium group 41 to the first back end 20-0 and provides the readout request ROR2 of the second storage medium group 42 to the second back end 20-1 in the controller 50 of the memory system 1. The readout requests ROR1, ROR2 can be processed in parallel for the first storage medium group 41 and the second storage medium group 42 mirrored with respect to each other.

Moreover, in the first embodiment, when receiving a response from one back end among the first back end 20-0 and the second back end 20-1, the front end transmits the data received from the relevant one back end to the host 100 in the controller 50 of the memory system 1. The data of the storage medium group, in which the advancement of the readout process is faster, among the first storage medium group 41 and the second storage medium group 42 thus can be adopted and transmitted to the host 100.

In the first embodiment, when receiving a response from one back end among the first back end 20-0 and the second back end 20-1, the front end 10 drops the readout request provided to the other back end or discards the data subsequently received from the other back end in the controller 50 of the memory system 1. The data of the storage medium group, in which the advancement of the readout process is slower, among the first storage medium group 41 and the second storage medium group 42 can be reliably rejected.

### Second Embodiment

The memory system 1 according to a second embodiment will now be described. A portion different from the first embodiment will be hereinafter mainly described.

In the first embodiment, the control focusing on whether or not the readout process is completed for the progress status of the readout process is carried out, but in the second embodiment, control that also takes into consideration whether or not a failure (ECC error) of error correction occurs for the progress status of the readout process is carried out in addition to the above control.

For example, in each of the first back end 20-0 and the second back end 20-1 illustrated in FIG. 1, the ECC encoder 24, for example, performs an encoder process of four stages, the first ECC code (L1), the second ECC code (L2), the third ECC code (L3), and the fourth ECC code (L4). The correction ability of the second ECC code (L2) is higher than the correction ability of the first ECC code (L1). The correction ability of the third ECC code (L3) is higher than the correction ability of the second ECC code (L2). The correction ability of the fourth ECC code (L4) is higher than the correction ability of the third ECC code (L3). In other words, the dispersion extent of the coding process becomes higher and the amount of data and number of pages of the coding target become larger, and thus the processing load becomes heavier in the order of the first ECC code (L1), the second ECC code (L2), the third ECC code (L3), and the fourth ECC code (L4).

For example, the data to be coded of the first ECC code (L1) and the second ECC code (L2) is the data in each NAND flash memory (one chip), whereas the data to be coded of the third ECC code (L3) and the fourth ECC code (L4) is the data across a plurality of NAND flash memories (a plurality of chips). In other words, the first ECC code (L1) is generated based on the data stored in one NAND flash memory chip. The second ECC code (L2) is generated based on the data stored in one NAND flash memory chip. The third ECC code (L3) is generated based on the data across a plurality of NAND flash memory chips. The fourth ECC code (L4) is generated based on the data across a plurality of NAND flash memory chips.

Alternatively, for example, the data to be coded of the first ECC code (L1) and the second ECC code (L2) is the data in one block, whereas the data to be coded of the third ECC code (L3) and the fourth ECC code (L4) is the data across a plurality of blocks. In other words, the first ECC code (L1) is generated based on the data stored in one block. The second ECC code (L2) is generated based on the data stored in one block. The third ECC code (L3) is generated based on the data across a plurality of blocks. The fourth ECC code (L4) is generated based on the data across a plurality of blocks.

Accordingly, the ECC decoder 25 first extracts the first ECC code (L1) and performs the error correction process using the first ECC code (L1), and when the ECC error occurs and the error correction process fails, extracts the second ECC code (L2) and performs the error correction process using the second ECC code (L2). Thus, the error correction process can be carried out while enlarging the scale in a step-wise manner in the order of the first ECC code (L1), the second ECC code (L2), the third ECC code (L3), and the fourth ECC code (L4) until the error correction process is successful.

In this case, for example, the data to be coded of the first ECC code (L1) and the second ECC code (L2) is the data in each NAND flash memory (one chip), whereas the data to be coded of the third ECC code (L3) and the fourth ECC code (L4) is the data across a plurality of NAND flash memories (a plurality of chips). The first ECC code (L1) and the second ECC code (L2) are written to each NAND flash memory (one chip), whereas the third ECC code (L3) and the fourth ECC code (L4) are written across a plurality of NAND flash memories (a plurality of chips). Thus, the load of the decode/error correction process of L3/L4 by the ECC decoder 25 has a possibility of becoming considerably large compared to the load of the decode/error correction process of L1/L2 by the ECC decoder 25.

For example, the data to be coded of the first ECC code (L1) and the second ECC code (L2) is the data in one block, whereas the data to be coded of the third ECC code (L3) and the fourth ECC code (L4) is the data across a plurality of blocks. The first ECC code (L1) and the second ECC code (L2) are written to one block, whereas the third ECC code (L3) and the fourth ECC code (L4) are written across a plurality of blocks. Thus, the load of the decode/error correction process of L3/L4 by the ECC decoder 25 has a possibility of becoming considerably large compared to the load of the decode/error correction process of L1/L2 by the ECC decoder 25.

In the second embodiment, each of the first back end 20-0 and the second back end 20-1 inquires the front end 10 whether to proceed from the decode/error correction process of L1/L2 to the decode/error correction process of L3/L4. Thus, if the readout process is completed in the other storage medium group of the mirrored storage medium groups before entering the ECC correction of heavy processing load of L3/L4, and the like, the data can be discarded without performing the ECC process, and thus a heavy process does not need to be executed to restore the data that will become unnecessary.

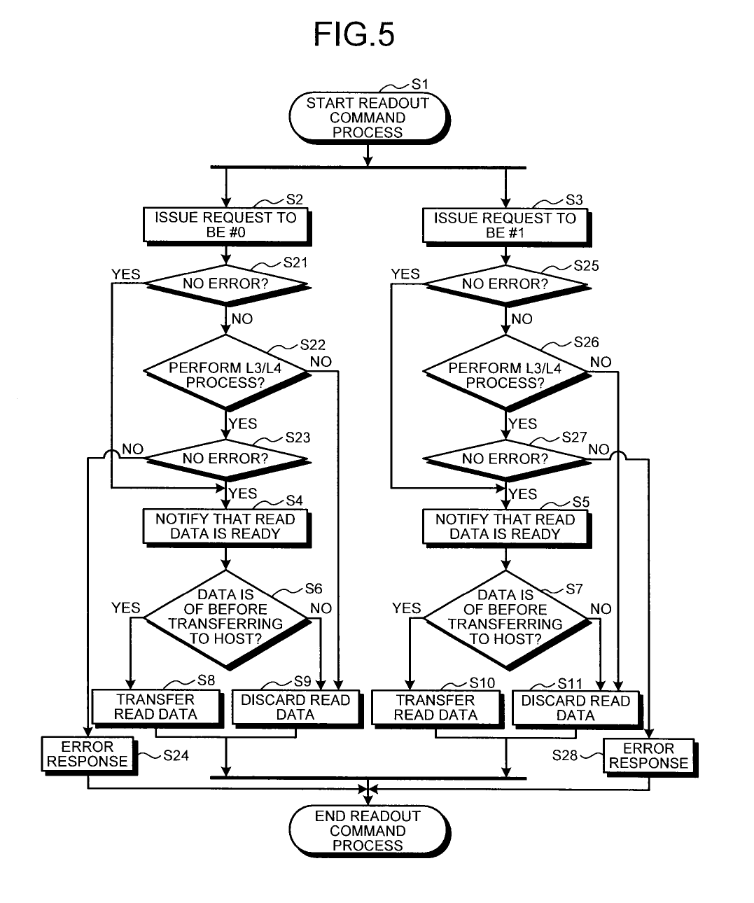

Specifically, as illustrated in FIG. 5, the process different from the first embodiment in the following aspects is performed. FIG. 5 is a flowchart illustrating the operation of the memory system 1.

In step S21, the first back end 20-0 determines whether or not the ECC error of L2 occurred in the decode/error correction process of L1/L2. For example, if the ECC error of L2 occurred in the decode/error correction process of L1/L2 (No in step S21), the first back end 20-0 inquires the front end 10 whether or not to perform the decode/error correction process of L3/L4, and proceeds the process to step S22. If the ECC error of L2 did not occur in the decode/error correction process of L1/L2, that is, if the decode/error correction process of L1/L2 is successful (Yes in step S21), the first back end 20-0 proceeds the process to step S4.

In step S22, the first back end 20-0 inquires the front end 10 on whether or not to perform the decode/error correction process of L3/L4, and waits for an instruction from the front end 10 with respect to the inquiry.

When receiving the inquiry on whether or not to perform the decode/error correction process of L3/L4 from the first back end 20-0, the front end 10 waits for a response from the second back end 20-1. When receiving a response (e.g., notification that the read data is ready) from the second back end 20-1, the front end 10 determines not to perform the decode/error correction process of L3/L4 in the first back end 20-0, and instructs the first back end 20-0 not to perform the decode/error correction process of L3/L4. Alternatively, when receiving the inquiry on whether or not to perform the decode/error correction process of L3/L4 from the second back end 20-1 as well, the front end 10 determines to perform the decode/error correction process of L3/L4 in the first back end 20-0, and instructs the first back end 20-0 to perform the decode/error correction process of L3/L4.

When receiving the instruction from the front end 10, the first back end 20-0 determines whether or not to perform the decode/error correction process of L3/L4 according to the instruction. When receiving the instruction to perform the decode/error correction process of L3/L4, the first back end 20-0 determines to perform the decode/error correction process of L3/L4 (Yes in step S22), and proceeds the process to step S23. When receiving an instruction that recovery by the decode/error correction process of L3/L4 is not necessary, the first back end 20-0 determines not to perform the decode/error correction process of L3/L4 (No in step S22), and proceeds the process to step S9.

In step S23, the first back end 20-0 determines whether or not the ECC error of L4 occurred in the decode/error correction process of L3/L4. For example, if the ECC error of L4 occurred in the decode/error correction process of L3/L4 (No in step S23), the first back end 20-0 notifies the front end 10 that the ECC error of L4 occurred, and proceeds the process to step S24. If the ECC error of L4 did not occur in the decode/error correction process of L3/L4, that is, if the decode/error correction process of L3/L4 is successful (Yes in step S23), the first back end 20-0 proceeds the process to step S4.

In step S24, the front end 10 transmits to the host 100 the information that the ECC error of L4 occurred for the data specified in the readout command as an error response.

In step S25, the second back end 20-1 determines whether or not the ECC error of L2 occurred in the decode/error correction process of L1/L2. For example, if the ECC error of L2 occurred in the decode/error correction process of L1/L2 (No in step S25), the second back end 20-1 inquires the front end 10 whether or not to perform the decode/error correction process of L3/L4, and proceeds the process to step S26. If the ECC error of L2 did not occur in the decode/error correction process of L1/L2, that is, if the decode/error correction process of L1/L2 is successful (Yes in step S25), the second back end 20-1 proceeds the process to step S5.

In step S26, the second back end 20-1 inquires the front end 10 whether or not to perform the decode/error correction process of L3/L4, and waits for an instruction from the front end 10 with respect to the inquiry.

When receiving the inquiry on whether or not to decode/error correction process of L3/L4 from the second back end 20-1, the front end 10 waits for a response from the first back end 20-0. When receiving a response (e.g., notification that the read data is ready) from the first back end 20-0, the front end 10 determines not to perform the decode/error correction process of L3/L4 in the second back end 20-1, and instructs the second back end 20-1 not to perform the decode/error correction process of L3/L4. Alternatively, when receiving the inquiry on whether or not to perform the decode/error correction process of L3/L4 from the first back end 20-0 as well, the front end 10 determines to perform the decode/error correction process of L3/L4 in the second back end 20-1, and instructs the second back end 20-1 to perform the decode/error correction process of L3/L4.

When receiving the instruction from the front end 10, the second back end 20-1 determines whether or not to perform the decode/error correction process of L3/L4 according to the instruction. When receiving the instruction to perform the decode/error correction process of L3/L4, the second back end 20-1 determines to perform the decode/error correction process of L3/L4 (Yes in step S26), and proceeds the process to step S27. When receiving an instruction that recovery by the decode/error correction process of L3/L4 is not necessary, the second back end 20-1 determines not to perform the decode/error correction process of L3/L4 (No in step S26), and proceeds the process to step S11.

In step S27, the second back end 20-1 determines whether or not the ECC error of L4 occurred in the decode/error correction process of L3/L4. For example, if the ECC error of L4 occurred in the decode/error correction process of L3/L4 (No in step S27), the second back end 20-1 notifies the front end 10 that the ECC error of L4 occurred, and proceeds the process to step S28. If the ECC error of L4 did not occur in the decode/error correction process of L3/L4, that is, if the decode/error correction process of L3/L4 is successful (Yes in step S27), the second back end 20-1 proceeds the process to step S5.

In step S28, the front end 10 transmits to the host 100 the information that the ECC error of L4 occurred for the data specified in the readout command as an error response.

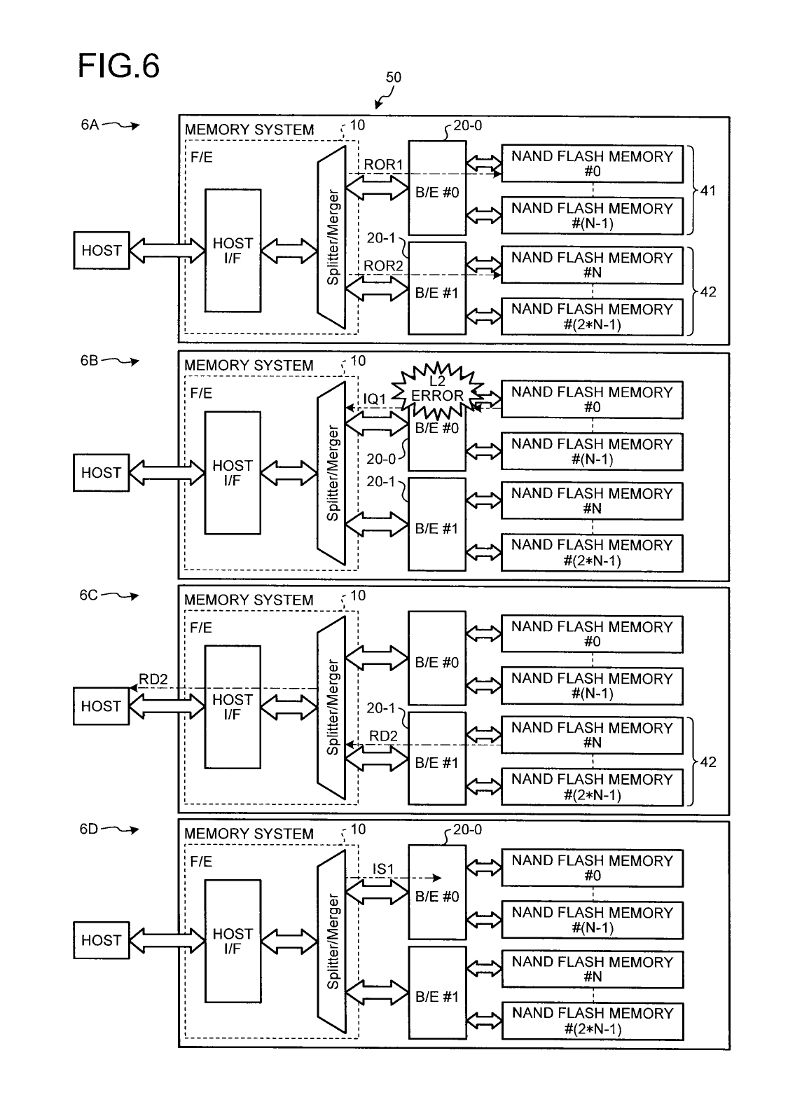

A specific operation example of the memory system 1 will now be described using FIGS. 6 to 8. FIGS. 6 to 8 are views illustrating the operation of the memory system 1.

For example, the operation similar to 3A of FIG. 3 is carried out in 6A of FIG. 6. In 6B of FIG. 6, the first back end 20-0 recognizes that the ECC error of L2 occurred in the decode/error correction process of L1/L2. The first back end 20-0 makes an inquiry IQ1 on whether or not to perform the decode/error correction process of L3/L4 to the front end 10 according to the occurrence of the ECC error of L2.

In 6C of FIG. 6, the front end 10 waits for the response from the second back end 20-1 when receiving the inquiry IQ1 on whether or not to perform the decode/error correction process of L3/L4 from the first back end 20-0. When receiving the response (e.g., notification that the read data is ready) from the second back end 20-1, the front end 10 acquires the data RD2 read out from the second storage medium group 42 from the second back end 20-1 and transmits the same to the host 100 in response to such notification. Alternatively, the front end 10 transmits the data RD2 received as a response from the second back end 20-1 to the host 100.

In 6D of FIG. 6, the front end 10 determines that the decode/error correction process of L3/L4 does not need to be performed in the first back end 20-0 according to the reception of the response (e.g., notification that the read data is ready) from the second back end 20-1, and provides an instruction IS1 to not perform the decode/error correction process of L3/L4 to the first back end 20-0. The first back end 20-0 receives an instruction that the recovery by the decode/error correction process of L3/L4 is not necessary from the front end 10. Accordingly, the first back end 20-0 cancels the error correction process of the data to be processed.

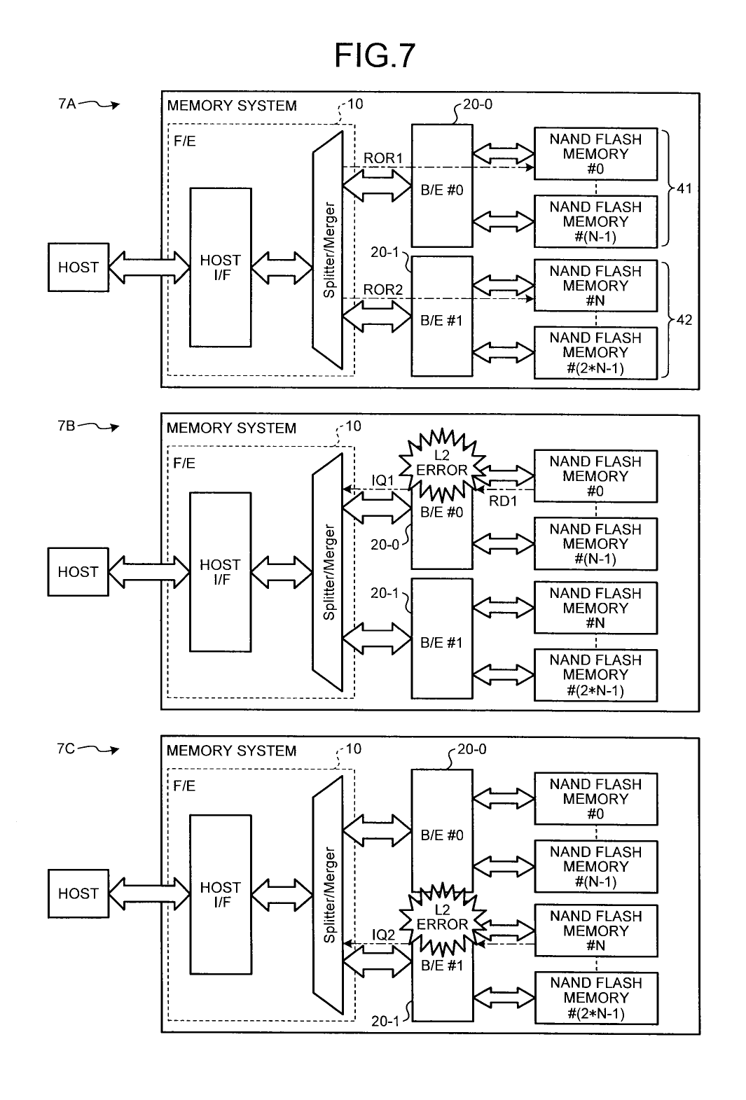

Alternatively, for example, the operations similar to 6A, 6B of FIG. 6 are carried out in 7A, 7B of FIG. 7. In 7C of FIG. 7, the second back end 20-1 recognizes that the ECC error of L2 occurred in the decode/error correction process of L1/L2. The second back end 20-1 makes an inquiry IQ2 on whether or not to perform the decode/error correction process of L3/L4 to the front end 10 according to the occurrence of the ECC error of L2.

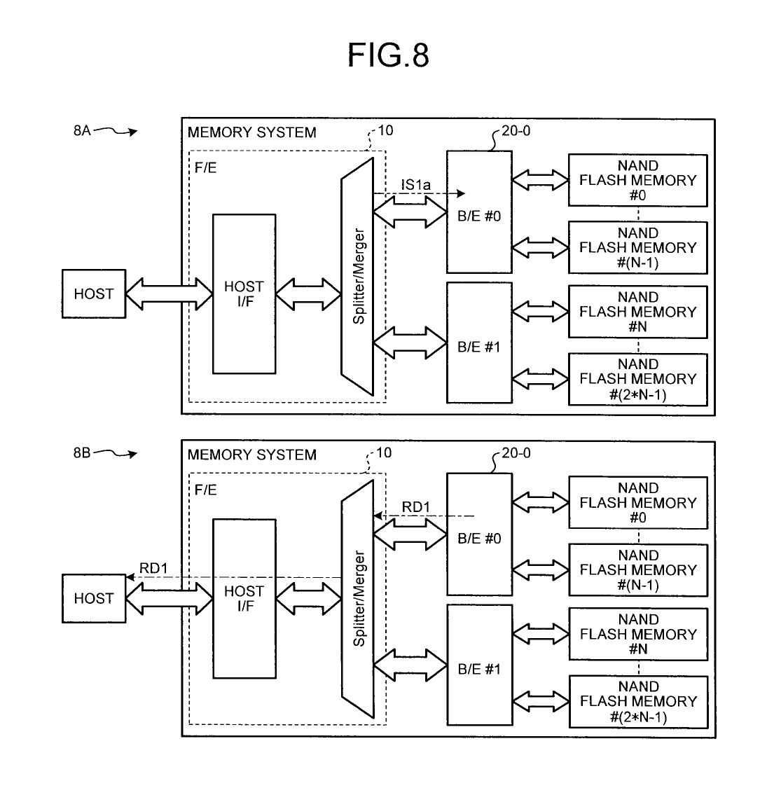

In 8A of FIG. 8, the front end 10 determines to perform the decode/error correction process of L3/L4 in the first back end 20-0 according to the reception of the inquiry IQ2 on whether or not to perform the decode/error correction process of L3/L4 from the second back end 20-1, and provides an instruction IS1a to perform the decode/error correction process of L3/L4 to the first back end 20-0.

In 8B of FIG. 8, the first back end 20-0 performs the decode/error correction process of L3/L4 according to the reception of the instruction to perform the decode/error correction process of L3/L4. The first back end 20-0 provides the data RD1 after the processing to the front end 10. The front end 10 transmits the provided data RD1 to the host 100.

Therefore, in the second embodiment, each of the first back end 20-0 and the second back end 20-1 performs the decode/error correction process of L1/L2 when processing the readout request, and inquires the front end 10 whether or not to perform the decode/error correction process of L3/L4 when the decode/error correction process of L1/L2 fails in the memory system 1. When receiving the inquiry on whether or not to perform the decode/error correction process of L3/L4 from one back end of the first back end 20-0 and the second back end 20-1, the front end 10 waits for the response from the other back end. When receiving the inquiry on whether or not to perform the decode/error correction process of L3/L4 from one back end and then receiving the response from the other back end, the front end 10 instructs the one back end to not perform the decode/error correction process of L3/L4.

Thus, if the readout process is completed in the other storage medium group of the mirrored storage medium groups before entering the ECC correction of heavy processing load of L3/L4, and the like, the data can be discarded without performing the ECC process, and thus a heavy process does not need to be executed to restore the data that will become unnecessary. In other words, the actuation of the ECC process having a heavy processing load performed for the block restoration, and the like can be suppressed, and the back end can be avoided from uselessly being busy and lowering the performance due to ECC correction. Therefore, the readout process can be carried out while suppressing the actuation of the ECC correction having a heavy processing load of L3/L4, and the like, so that the response from one storage medium group can be suppressed from becoming slow and the speed of the readout process can be increased for the first storage medium group 41 and the second storage medium group 42, which are mirrored with respect to each other, in the memory system 1.

Furthermore, in the second embodiment, when receiving the inquiry on whether or not to perform the decode/error correction process of L3/L4 from one back end, and then receiving the inquiry on whether or not to perform the decode/error correction process of L3/L4 from the other back end, the front end 10 instructs the one back end to perform the decode/error correction process of L3/L4 in the memory system 1. The ECC correction having a heavy processing load of L3/L4, and the like thus can be actuated, if necessary.

### Third Embodiment

The memory system 1 according to a third embodiment will now be described. A portion different from the first embodiment will be hereinafter mainly described.

In the first embodiment, the control focusing on whether or not the readout process is completed for the progress status of the readout process is carried out, but in the third embodiment, control that also takes into consideration whether or not a failure (ECC error) of error correction occurs for the progress status of the readout process is carried out in place of the above control.

Specifically, the readout request that is first input is limited to the back end on one side, the readout request is issued to another back end at the stage detection is made that it is necessary to enter the ECC having a heavy processing load of L3/L4, and the like, and input control for giving the instruction to enter L3/L4 for the first time when the data cannot be acquired in either case may be carried out. The algorithm of the back end to select first in this case may comply with the round-robbin method, the geometric method, or the fixation method described above.

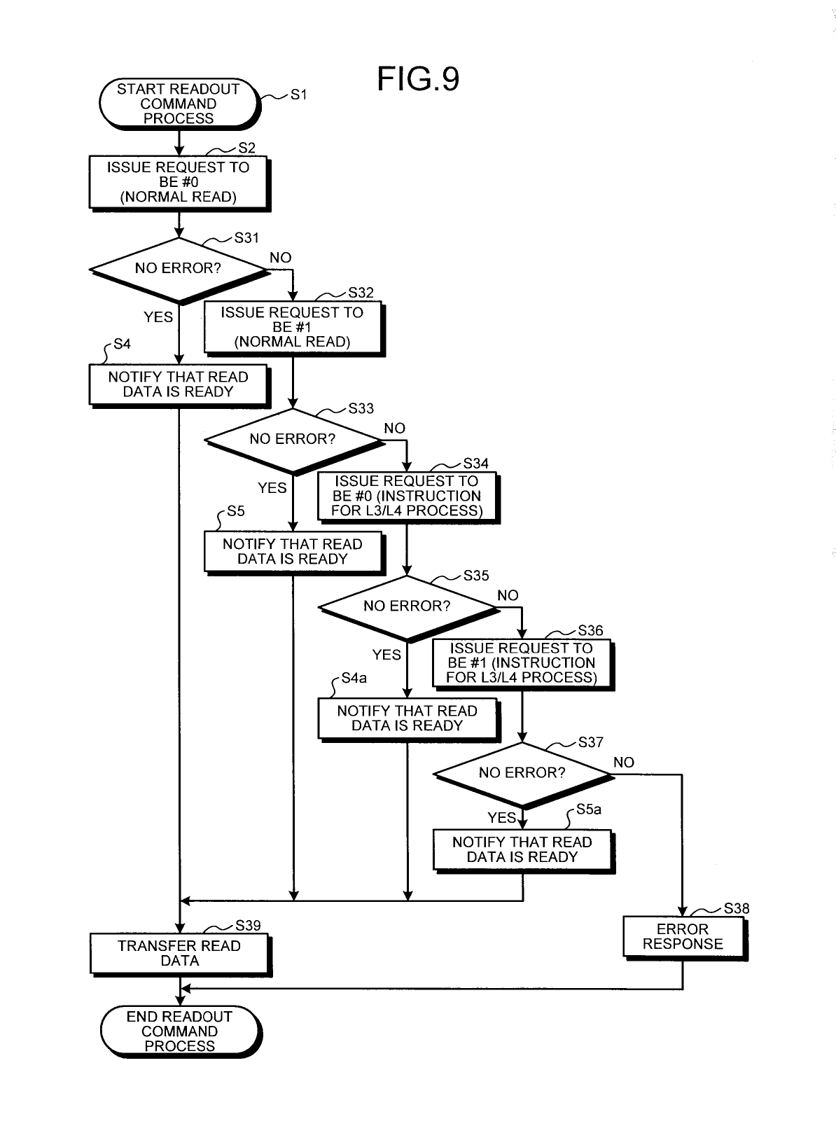

For example, the operation of the memory system 1 of when the readout request is first input to the first back end 20-0 is carried out as illustrated in FIG. 9. FIG. 9 is a flowchart illustrating the operation of the memory system 1.

In step S31, the first back end 20-0 determines whether or not the ECC error of L2 occurred in the decode/error correction process of L1/L2. For example, if the ECC error of L2 occurred in the decode/error correction process of L1/L2 (No in step S31), the first back end 20-0 inquires the front end 10 whether or not to perform the decode/error correction process of L3/L4, and proceeds the process to step S32. If the ECC error of L2 did not occur in the decode/error correction process of L1/L2, that is, if the decode/error correction process of L1/L2 is successful (Yes in step S31), the first back end 20-0 proceeds the process to step S4.

In step S32, the front end 10 issues the readout request for the second storage medium group 42 and provides to the second back end 20-1 when receiving from the first back end 20-0 the inquiry on whether or not to perform the decode/error correction process of L3/L4.

In step S33, the second back end 20-1 determines whether or not the ECC error of L2 occurred in the decode/error correction process of L1/L2. For example, if the ECC error of L2 occurred in the decode/error correction process of L1/L2 (No in step S33), the second back end 20-1 inquires the front end 10 whether or not to perform the decode/error correction process of L3/L4, and proceeds the process to step S34. If the ECC error of L2 did not occur in the decode/error correction process of L1/L2, that is, if the decode/error correction process of L1/L2 is successful (Yes in step S33), the second back end 20-1 proceeds the process to step S5.

In step S34, the front end 10 instructs the first back end 20-0 to perform the decode/error correction process of L3/L4 according to the reception of the inquiry on whether or not to perform the decode/error correction process of L3/L4 from both the first back end 20-0 and the second back end 20-1.

In step S35, the first back end 20-0 determines whether or not the ECC error of L4 occurred in the decode/error correction process of L3/L4. For example, if the ECC error of L4 occurred in the decode/error correction process of L3/L4 (No in step S35), the first back end 20-0 notifies the front end 10 that the ECC error of L4 occurred, and proceeds the process to step S36. If the ECC error of L4 did not occur in the decode/error correction process of L3/L4, that is, if the decode/error correction process of L3/L4 is successful (Yes in step S35), the first back end 20-0 proceeds the process to step S4a. In step S4a, the operation similar to step S4 is carried out.

In step S36, the front end 10 instructs the second back end 20-1 to perform the decode/error correction process of L3/L4 according to the occurrence of the ECC error of L4 in the first back end 20-0.

In step S37, the second back end 20-1 determines whether or not the ECC error of L4 occurred in the decode/error correction process of L3/L4. For example, if the ECC error of L4 occurred in the decode/error correction process of L3/L4 (No in step S37), the second back end 20-1 notifies the front end 10 that the ECC error of L4 occurred, and proceeds the process to step S38. If the ECC error of L4 did not occur in the decode/error correction process of L3/L4, that is, if the decode/error correction process of L3/L4 is successful (Yes in step S37), the second back end 20-1 proceeds the process to step S5a. In step S5a, the operation similar to step S5 is carried out.

In step S38, the front end 10 makes an error response when notified that the ECC error of L4 occurred from both the first back end 20-0 and the second back end 20-1. In other words, the front end 10 transmits to the host 100 the information that the ECC error of L4 occurred for the data specified in the readout command as an error response.

In step S39, the front end 10 acquires the data read out from the first storage medium group 41 from the first back end 20-0, and transmits the data to the host 100 according to the notification that the data is ready from the first back end 20-0. Alternatively, the front end 10 acquires the data read out from the second storage medium group 42 from the second back end 20-1 and transmits the data to the host 100 according to the notification that the data is ready from the second back end 20-1. Alternatively, the front end 10 transmits the data received from the first back end 20-0 in step S4, S4a to the host 100. Alternatively, the front end 10 transmits the data received from the second back end 20-1 in step S5, S5a to the host 100.

When the readout request is first input to the second back end 20-1, the description made above can be similarly applied by interchanging the first back end 20-0 and the second back end 20-1.

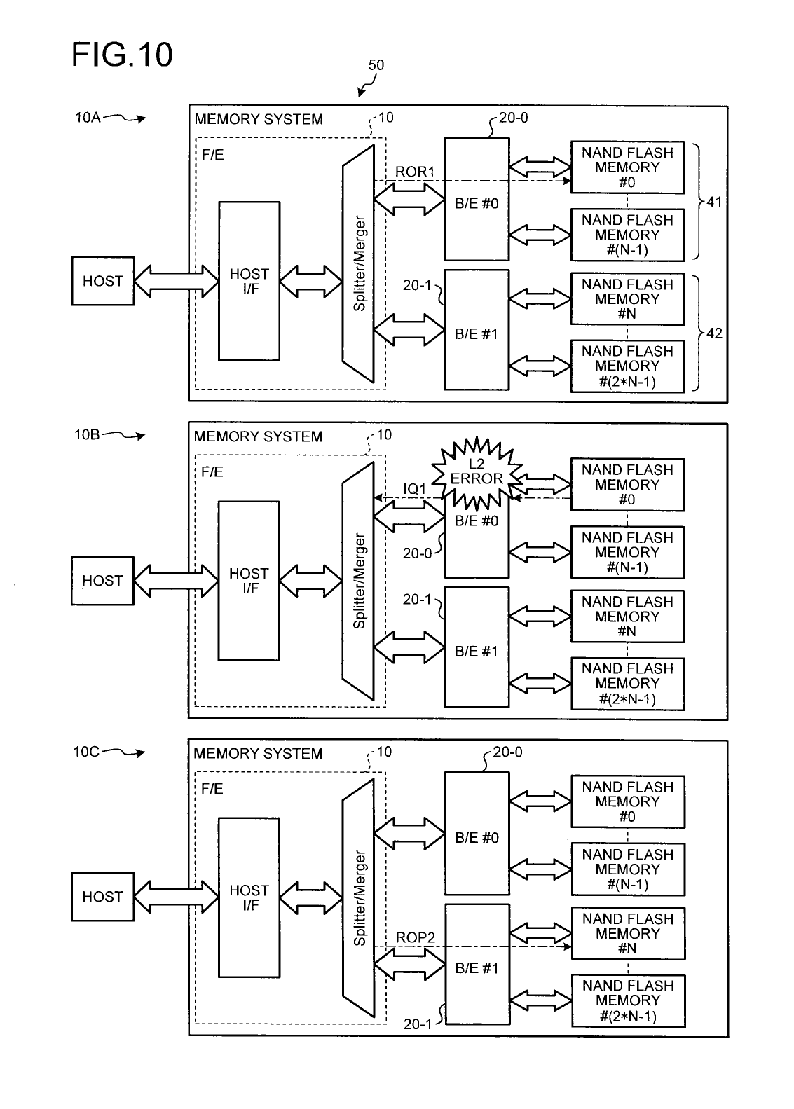

A specific operation example of the memory system 1 will now be described using FIG. 10 to FIG. 13. FIG. 10 to FIG. 13 are views illustrating the operation of the memory system 1.

In 10A of FIG. 10, the front end 10 receives a readout command from the host 100, and issues a readout request according to the readout command. In this case, the front end 10 temporarily selects one storage medium group from the first storage medium group 41 and the second storage medium group 42, and issues the readout request for one storage medium group according to the round-robbin method, the geometric method, the fixation method, and the like. For example, the front end 10 temporarily selects the first storage medium group 41, and issues the readout request ROR1 for the first storage medium group 41. The front end 10 provides the readout request ROR1 of the first storage medium group 41 to the first back end 20-0.

In 10B of FIG. 10, the first back end 20-0 recognizes that the ECC error of L2 occurred in the decode/error correction process of L1/L2. The first back end 20-0 makes an inquiry IQ1 on whether or not to perform the decode/error correction process of L3/L4 to the front end 10 according to the occurrence of the ECC error of L2.

In 100 of FIG. 10, the front end 10 issues the readout request ROR2 for the second storage medium group 42, which is the other storage medium group of the first storage medium group 41 and the second storage medium group 42 that are mirrored, according to the reception of the inquiry IQ1 on whether or not to perform the decode/error correction process of L3/L4 from the first back end 20-0. The front end 10 provides the readout request ROR2 for the second storage medium group 42 to the second back end 20-1.

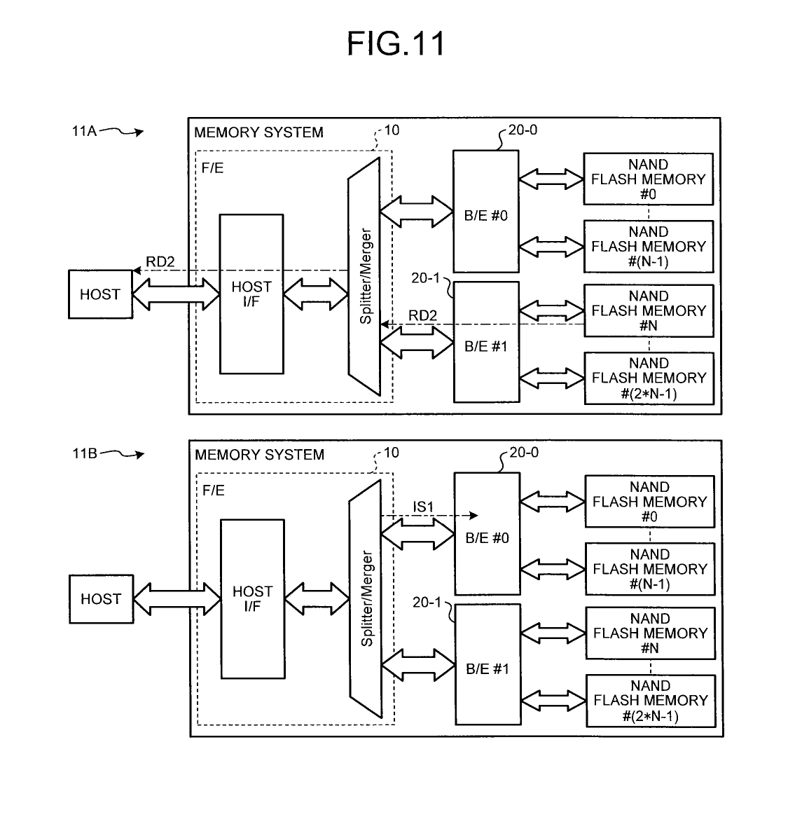

In 11A of FIG. 11, the front end 10 waits for a response from the second back end 20-1 with respect to the readout request ROR2. When receiving the response (e.g., notification that the read data is ready) from the second back end 20-1, the front end 10 acquires the data RD2 read out from the second storage medium group 42 from the second back end 20-1 and transmits the same to the host 100 in response to such notification. Alternatively, the front end 10 transmits the data RD2 received as a response from the second back end 20-1 to the host 100.

In 11B of FIG. 11, the front end 10 determines not to perform the decode/error correction process of L3/L4 in the first back end 20-0, and provides the instruction IS1 to not perform the decode/error correction process of L3/L4 to the first back end 20-0 according to the reception of the response (e.g., notification that the read data is ready) from the second back end 20-1. The first back end 20-0 receives an instruction that the recovery by the decode/error correction process of L3/L4 is not necessary from the front end 10. Accordingly, the first back end 20-0 cancels the error correction process of the data to be processed.

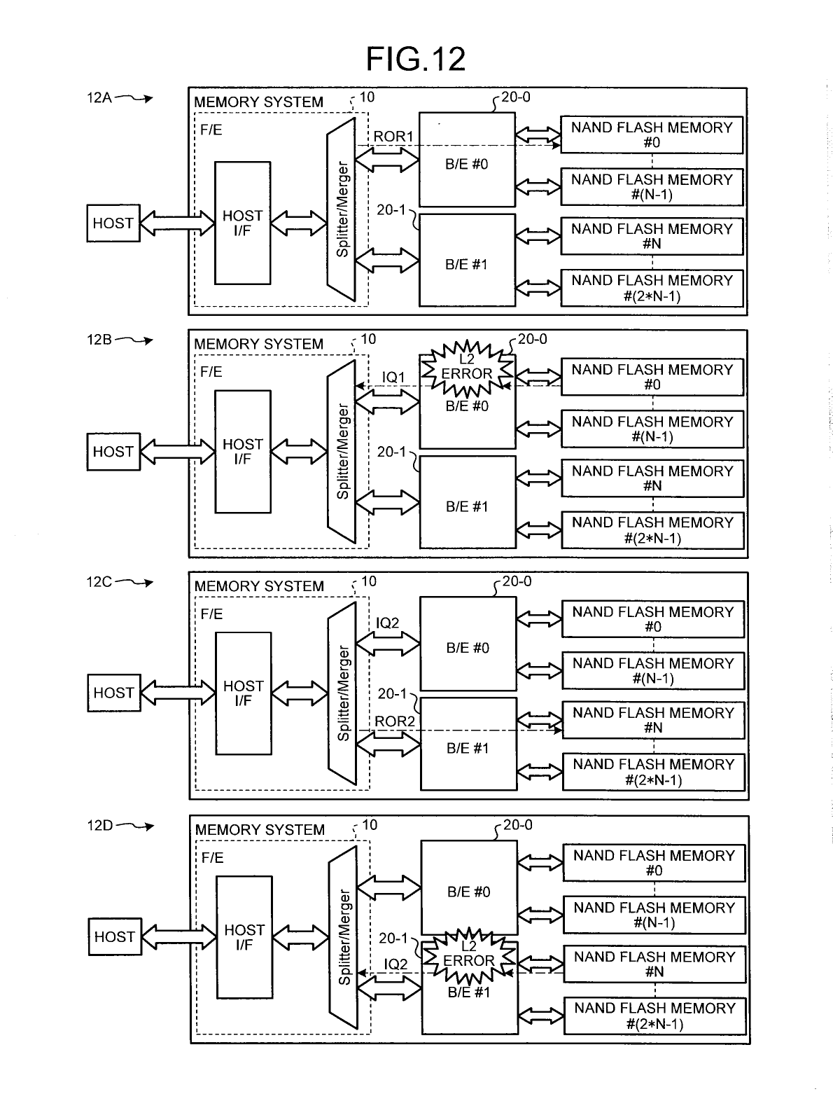

Alternatively, for example, the operations similar to 10A to 10C of FIG. 10 are carried out in 12A to 12C of FIG. 12. In 12D of FIG. 12, the second back end 20-1 recognizes that the ECC error of L2 occurred in the decode/error correction process of L1/L2. The second back end 20-1 makes an inquiry IQ2 on whether or not to perform the decode/error correction process of L3/L4 to the front end 10 according to the occurrence of the ECC error of L2.

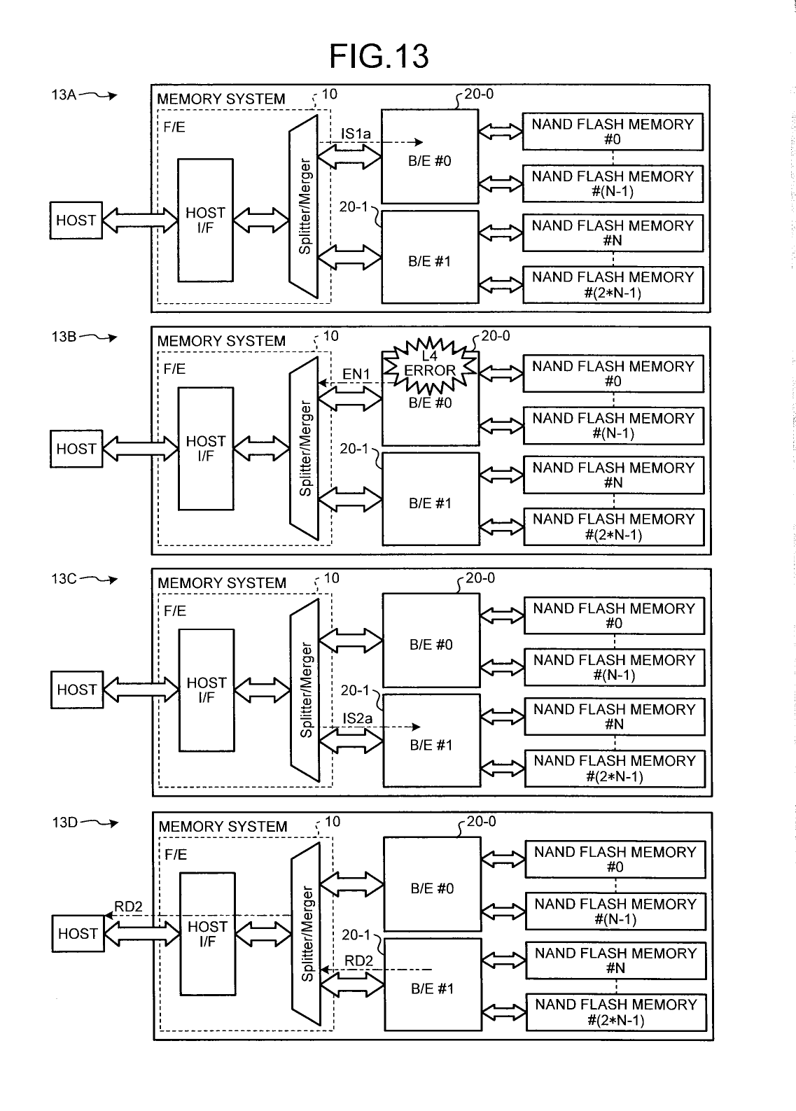

In 13A of FIG. 13, the front end 10 determines to perform the decode/error correction process of L3/L4 in the first back end 20-0 according to the reception of the inquiry IQ2 on whether or not to perform the decode/error correction process of L3/L4 from the second back end 20-1, and provides an instruction IS1a to perform the decode/error correction process of L3/L4 to the first back end 20-0.

In 13B of FIG. 13, the first back end 20-0 performs the decode/error correction process of L3/L4 according to the instruction IS1a. The first back end 20-0 recognizes that the ECC error of L4 occurred in the decode/error correction process of L3/L4. The first back end 20-0 makes the notification EN1 that the ECC error of L4 occurred to the front end 10 according to the occurrence of the ECC error of L4.

In 13C of FIG. 13, the front end 10 determines to perform the decode/error correction process of L3/L4 in the second back end 20-1 according to the reception of the notification EN1 that the ECC error of L4 occurred from the first back end 20-0, and provides an instruction IS 2a to perform the decode/error correction process of L3/L4 to the second back end 20-1.

In 13D of FIG. 13, the second back end 20-1 performs the decode/error correction process of L3/L4 according to the reception of the instruction to perform the decode/error correction process of L3/L4. The second back end 20-1 provides the data RD2 after the processing to the front end 10. The front end 10 transmits the provided data RD2 to the host 100.

Therefore, in the third embodiment, the controller 50 temporarily selects one storage medium group from the first storage medium group 41 and the second storage medium group 42 and issues the readout request for the one storage medium group when receiving the readout command from the host 100 in the memory system 1. When the decode/error correction process of L1/L2 ends in failure when processing the readout request on one storage medium side, the controller 50 issues the readout request for the other storage medium group of the first storage medium group 41 and the second storage medium group 42. The controller 50 determines whether or not to perform the decode/error correction process of L3/L4 on one storage medium side according to the response from the other storage medium side, and selects the storage medium group in which the readout process of the data is to be completed according to the determination result.

Thus, if the readout process is completed in the other storage medium group of the mirrored storage medium groups before entering the ECC correction of heavy processing load of L3/L4, and the like, the data can be discarded without performing the ECC process, and thus a heavy process does not need to be executed to restore the data that will become unnecessary. In other words, the actuation of the ECC process having a heavy processing load performed for the block restoration, and the like can be suppressed, and the back end can be avoided from uselessly being busy and lowering the performance due to ECC correction. Therefore, the readout process can be carried out while suppressing the actuation of the ECC correction having a heavy processing load of L3/L4, and the like, so that the response from one storage medium group can be suppressed from becoming slow and the speed of the readout process can be increased for the first storage medium group 41 and the second storage medium group 42, which are mirrored with respect to each other, in the memory system 1.

### Fourth Embodiment

The memory system 1 according to a fourth embodiment will now be described. A portion different from the first embodiment will be hereinafter mainly described.

In the first embodiment, the control corresponding to the progress status of the readout process is carried out, but in the fourth embodiment, the load status in each back end is estimated in advance, and the control following the estimation result is carried out.

For example, the background process such as wear leveling, compaction is sometimes performed in either the first back end 20-0 or the second back end 20-1 illustrated in FIG. 1.

In the wear leveling, the data is moved from the cell in which the number of write is large to the cell in which the number of writes is small in the NAND flash memory to perform the process of uniformizing the number of writes of all the cells. In other words, since the back end reads out the data from the NAND flash memory and performs rewrite, the possibility of the processing load in the back end becoming heavy is high.

In the compaction process, a process of generating a new free block (logical block not assigned with application) by collecting the effective data of a plurality of logical blocks in the NAND flash memory and rewriting to another logical block is carried out. In other words, since the back end reads out the data from the NAND flash memory and performs rewrite, the possibility of the processing load in the back end becoming heavy is high.

According to such background process, the possibility of the processing load in the back end becoming heavy is high, and hence the load of the back end can be estimated to become heavy if it can be grasped at the stage the execution of the background process is scheduled. However, it is difficult for the front end to grasp the load of the back end since the background process is autonomously carried out on the back end side.

In the fourth embodiment, a notifying unit for notifying the load information indicating a load status from each back end 20-0, 20-1 to the front end 10 illustrated in FIG. 1 is arranged. The load information includes, for example, an execution schedule of the background process such as wear leveling, compaction, or the like. The execution schedule of the background process includes, for example, a start time of the background process, and may further include a finish scheduled time of the background process. The notifying unit, for example, may be mounted in a form of a circuit in the CPU 21 of each back end 20-0, 20-1, or may be mounted in a form of software in the firmware executed by the CPU 21 of each back end 20-0, 20-1.

When the load information is notified from the back end 20-0, 20-1, the front end 10 compares the load status of the first back end 20-0 and the second back end 20-1 according to the load information, and preferentially issues the readout request with respect to the back end with the lighter load status.

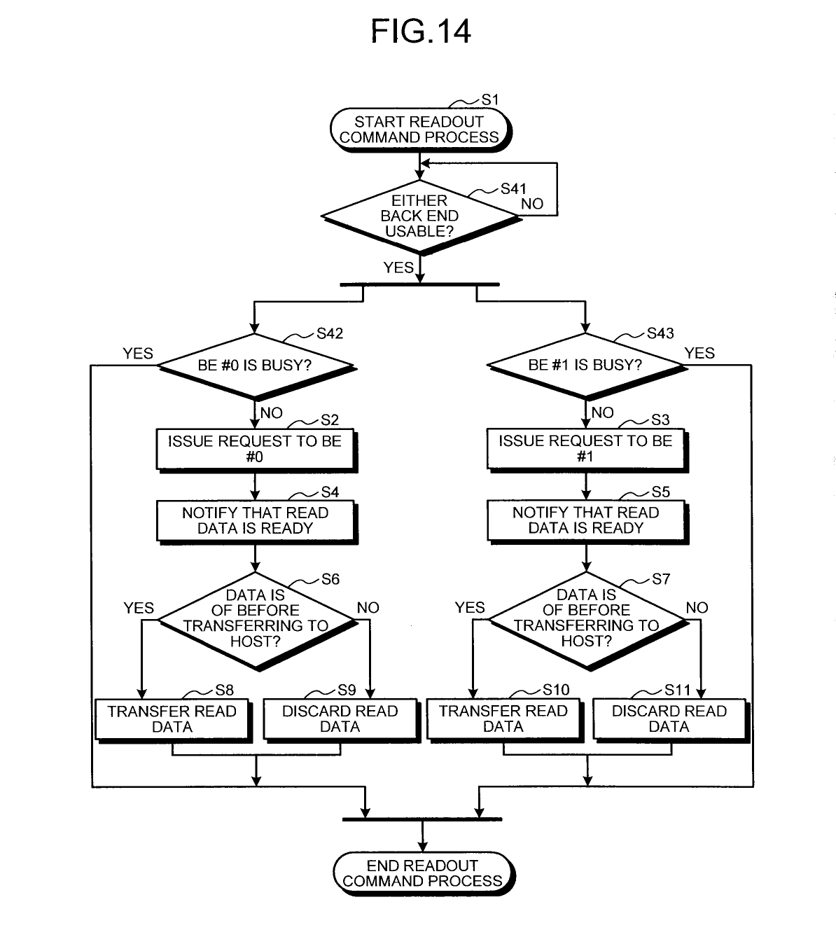

For example, the operation of the memory system 1 differs from the first embodiment in the following points, as illustrated in FIG. 14. FIG. 14 is a flowchart illustrating the operation of the memory system 1.

In step S41, the front end 10 determines whether or not at least one back end of the first back end 20-0 or the second back end 20-1 is usable. For example, when determining that both the first back end 20-0 and the second back end 20-1 are immediately before the execution of or in the middle of the execution of the background process (No in step S41) according to the load information notified from the first back end 20-0 and the load information notified from the second back end 20-1, the front end 10 proceeds the process to step S41. When determining that there is sufficient time until the execution of the background process or that execution is not scheduled in at least one of the first back end 20-0 and the second back end 20-1 (Yes in step S41) according to the load information notified from the first back end 20-0 and the load information notified from the second back end 20-1, the front end 10 proceeds the process to step S42 and step S43.

In step S42, the front end 10 determines whether or not the possibility of the first back end 20-0 becoming the busy state by the background process is high according to the load information notified from the first back end 20-0. For example, the front end 10 acquires information on the current time by inquiring the host 100, and the like. The front end 10 compares the start time of the background process included in the load information and the acquired current time, and determines whether or not the processing period of the readout process overlaps the processing period of the background process if the readout process is executed in the first back end 20-0. When determining that the processing period of the readout process overlaps the processing period of the background process, the front end 10 terminates the process on the left side in FIG. 14 assuming the possibility of becoming the busy state by the background process is high (Yes in step S42). When determining that the processing period of the readout process does not overlap the processing period of the background process, the front end 10 proceeds the process on the left side in FIG. 14 to step S2 assuming the possibility of becoming the busy state by the background process is low (No in step S42).

In step S43, the front end 10 determines whether or not the possibility of the second back end 20-1 becoming the busy state by the background process is high according to the load information notified from the second back end 20-1. For example, the front end 10 acquires information on the current time by inquiring the host 100, and the like. The front end 10 compares the start time of the background process included in the load information and the acquired current time, and determines whether or not the processing period of the readout process overlaps the processing period of the background process if the readout process is executed in the second back end 20-1. When determining that the processing period of the readout process overlaps the processing period of the background process, the front end 10 terminates the process on the right side in FIG. 14 assuming the possibility of becoming the busy state by the background process is high (Yes in step S43). When determining that the processing period of the readout process does not overlap the processing period of the background process, the front end 10 proceeds the process on the left side in FIG. 14 to step S3 assuming the possibility of becoming the busy state by the background process is low (No in step S43).

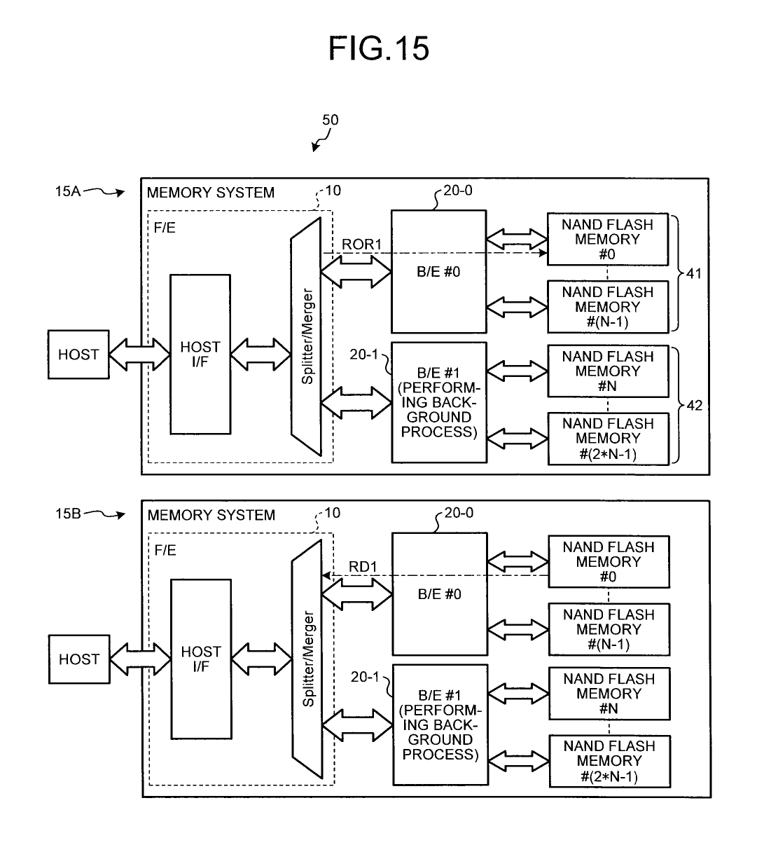

A specific operation example of the memory system 1 will now be described using FIG. 15. FIG. 15 is a view illustrating the operation of the memory system 1.

In 15A of FIG. 15, the front end 10 receives a readout command from the host 100, and issues a readout request according to the readout command. In this case, the front end 10 compares the load statuses for the first storage medium group 41 and the second storage medium group 42, selects the storage medium group with the lighter load, and issues the readout request for the selected storage medium group. In other words, the front end 10 compares the load statuses of the first back end 20-0 and the second back end 20-1 according to the load information notified from the first back end 20-0 and the load information notified from the second back end 20-1, and provides the readout request for the storage medium group to one back end when the load of one back end, the first back end 20-0 or the second back end 20-1, is lighter than the load of the other back end.

For example, when determining that the background process is not scheduled to be executed in the first back end 20-0 and the background process is being executed in the second back end 20-1, the front end 10 determines that the load of the first back end 20-0 is lighter than the load of the second back end 20-1. The front end 10 then selects the first storage medium group 41 with the lighter load, issues the readout request ROR1 for the first storage medium group 41, and provides the same to the first back end 20-0.

Thereafter, as illustrated in 15B of FIG. 15, the front end 10 receives the data RD1 read out from the first storage medium group 41 from the first back end 20-0, and transmits the same to the host 100.

As described above, in the fourth embodiment, the controller 50 compares the load statuses for the first storage medium group 41 and the second storage medium group 42, selects the storage medium group with the lighter load, issues the readout request for the selected storage medium group, and transmits the data read out from the selected storage medium group to the host 100 in the memory system 1. In other words, the front end 10 compares the load statuses of the first back end 20-0 and the second back end 20-1 according to the load information notified from the first back end 20-0 and the second back end 20-1, provides the readout request for the storage medium group to one back end when the load of one back end, the first back end 20-0 or the second back end 20-1, is lighter than the load of the other back end, and transmits the data read out from the relevant one back end to the host 100.

Therefore, even if a certain back end storage region is busy, the data from another region that is not busy is used to return the response without using the back end storage region that is busy, so that stable performance can be derived for the readout process in the memory system 1. For example, it is particularly effective when warning can be made beforehand that the load will rise such as compaction, wear leveling, and the like. In other words, the reliability can be enhanced for the NAND flash memory in which the number of read is limited since the unnecessary readout request can be suppressed from being issued.

In the first embodiment as well, the number of reads is limited to the number of readout same as the number of read in a non-mirrored case, and thus the number of read does not increase by mirroring.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
a first storage medium group;
a second storage medium group; and
a controller configured to multiply write a same data to the first storage medium group and the second storage medium group, and transmit, when receiving a readout command of stored data in the first storage medium group and the second storage medium group from the host, data read out from a storage medium group selected from the first storage medium group and the second storage medium group to a host according to a progress status of a readout process for the first storage medium group and the second storage medium group.

2. The memory system according to claim 1, wherein
when receiving the readout command of the stored data from the host, the controller issues a readout request for each of the first storage medium group and the second storage medium group, adopts the data read out from the storage medium group that has first made a response among the first storage medium group and the second storage medium group and transmits the read-out data to the host.

3. The memory system according to claim 2, wherein
the controller includes
a front end configured to communicate with the host,
a first back end connected between the front end and the first storage medium group, and
a second back end connected between the front end and the second storage medium group.

4. The memory system according to claim 3, wherein
when receiving the readout command of the stored data from the host, the front end provides a readout request for the first storage medium group to the first back end and provides a readout request for the second storage medium group to the second back end.

5. The memory system according to claim 4, wherein
when receiving the response from one back end of the first back end and the second back end, the front end transmits data received from the one back end to the host, and drops the readout request provided to an other back end or discards the data subsequently received from the other back end.

6. The memory system according to claim 5, wherein
each of the first back end and the second back end performs a first error correction process when processing the readout request, and inquires, when the first error correction process fails, the front end whether or not to perform a second error correction process having error correction ability higher than error correction ability of the first error correction process.

7. The memory system according to claim 6, wherein
when receiving the inquiry on whether or not to perform the second error correction process from one back end of the first back end and the second back end, the front end waits for a response from an other back end.

8. The memory system according to claim 7, wherein
when receiving the response from the other back end after receiving the inquiry on whether or not to perform the second error correction process from the one back end, the front end instructs the one back end not to perform the second error correction process.

9. The memory system according to claim 7, wherein
when receiving the inquiry on whether or not to perform the second error correction process from the other back end after receiving the inquiry on whether or not to perform the second error correction process from the one back end, the front end instructs the one back end to perform the second error correction process.

10. The memory system according to claim 1, wherein
the controller issues a readout request with respect to one storage medium group of the first storage medium group and the second storage medium group when receiving the readout command of the stored data from the host, issues a readout request with respect to the other storage medium group of the first storage medium group and the second storage medium group when a first error correction process fails upon processing the readout request in the one storage medium group, and performs a third error correction process on the one storage medium group when a second error correction process fails upon processing the readout request in the other storage medium group, error correction ability of the third error correction process being higher than error correction ability of the first error correction process.

11. The memory system according to claim 10, wherein
the first storage medium group includes a plurality of NAND flash memory chips,
the second storage medium group includes a plurality of NAND flash memory chips,
a first error correction code used in the first error correction process is generated based on data stored in one NAND flash memory chip,
a second error correction code used in the second error correction process is generated based on data stored in one NAND flash memory chip, and
a third error correction code used in the third error correction process is generated based on data across the plurality of NAND flash memory chips.

12. The memory system according to claim 10, wherein
a first error correction code used in the first error correction process is generated based on data stored in one block,
a second error correction code used in the second error correction process is generated based on data stored in one block, and
a third error correction code used in the third error correction process is generated based on data across a plurality of blocks.

13. The memory system according to claim 11, wherein
the controller includes
a front end connectable to the host,
a first back end connected between the front end and the first storage medium group, and
a second back end connected between the front end and the second storage medium group, and
the front end temporarily selects one back end from the first back end and the second back end, and provides a readout request for the storage medium group to one back end when receiving the readout command of the stored data from the host, and
the one back end performs the first error correction process when processing the readout request, and inquires the front end whether or not to perform the second error correction process when the first error correction process fails.

14. The memory system according to claim 13, wherein
when receiving the inquiry on whether or not to perform the second error correction process from the one back end, the front end provides a readout request for the storage medium group to the other back end of the first back end and the second back end, and waits for a response from the other back end.

15. The memory system according to claim 14, wherein
when receiving the response from the other back end after receiving the inquiry on whether or not to perform the second error correction process from the one back end, the front end determines not to perform the second error correction process in the one back end and instructs the one back end to not perform the second error correction process.

16. The memory system according to claim 14, wherein
the other back end performs the first error correction process when processing the readout request, and inquires the front end on whether or not to perform the second error correction process when the first error correction process fails, and
the front end determines to perform the second error correction process in the one back end and instructs the one back end to perform the second error correction process when receiving the inquiry on whether or not to perform the second error correction process from the other back end after receiving the inquiry on whether or not to perform the second error correction process from the one back end.

17. A memory system comprising:
a first storage medium group;
a second storage medium group; and
a controller configured to multiply write a same data to the first storage medium group and the second storage medium group, select a storage medium group according to a load status of each of the first storage medium group and the second storage medium group when receiving a readout command of stored data from a host, issue a readout request for the selected storage medium group, and transmit data read out from the selected storage medium group to the host.

18. The memory system according to claim 17, wherein
the controller includes
a front end connectable to the host,
a first back end connected between the front end and the first storage medium group, and
a second back end connected between the front end and the second storage medium group.

19. The memory system according to claim 18, wherein
each of the first back end and the second back end notifies load information indicating a load status to the front end, and
the front end compares load statuses of the first back end and the second back end according to the notified load information when receiving a readout command of the stored data from the host, provides, if a load of one back end of the first back end and the second back end is lighter than a load of an other back end, the readout request for the storage medium group to the one back end, and transmits the data read out from the one back end to the host.

20. The memory system according to claim 19, wherein
information indicating the load status includes at least one of information indicating that compaction is being carried out, and information indicating that wear leveling is being carried out.
